(19) United States
(12) Patent Application Publication
(10) Pub. No.: US 2007/0292740 A1
(43) Pub. Date: Dec. 20, 2007

(54) FUEL FLOW BOARD FOR FUEL CELL

(76) Inventors: HSI-MING SHU, Taipei (TW); TSANG-MING CHANG, Taipei (TW); YEAN-DER KUAN, Taipei (TW); CHIH-JUNG KAO, Taipei (TW)

Correspondence Address: G. LINK CO ., LTD, 3550 BELL ROAD, MINOOKA, IL, 60447, US

(21) Appl. No.: 11/425,129

(22) Filed: Jun. 19, 2006

(51) Int. Cl. H01M 8/02; B32B 3/30; B32B 3/28

(52) U.S. Cl. 429/38; 428/167

(57) ABSTRACT

A fuel flow board of a fuel cell is disclosed, which is sandwiched between an upper fuel cell board and a lower fuel cell board, and each fuel cell board includes at least a membrane electrode assembly (MEA). The fuel flow board comprises a substrate having a first surface, a second surface and a fuel flowing channel. The fuel flowing channel is individually disposed on each surface in the form of a concave flow-guiding structure. The first surface and the second surface are contacted with the upper fuel cell board and the lower fuel cell board, respectively. The fuel flowing channel on each surface includes a plurality of trenches defined in parallel. The trenches are disposed corresponding to membrane electrode assemblies of the upper fuel cell board and the lower fuel cell board, and are spaced apart and interlaced on the first surface and the second surface.

### FIELD OF THE INVENTION

The present invention relates to a fuel flow board of a fuel cell, and more particularly, to a structure of a fuel flow board, which includes channels spaced apart and interlaced with each other on the first surface (upper surface) and the second surface (lower surface) of the fuel flow board corresponding to the membrane electrode assemblies (MEAs).

### BACKGROUND OF THE INVENTION

Conventional fuel cells generally utilize redox reactions of hydrogen-containing fuels like reactants, including liquid fuels, such as methanol, and produce products including water and carbon dioxide after performing the reactions. Consequently, this kind of fuel cell needs a container for containing liquid fuels and a flow structure for flowing fuels.

In addition, the structure of fuel flow board with a substrate is used to provide fuels for the fuel cell. As fuels come into contact with the MEAs, electrochemical reactions are initialized to generate power. During the electrochemical reactions, the MEAs also produce gaseous products that may accumulate within flow-guiding channels and retard the flow of fuels due to great surface tension resulting from the channels themselves. To solve the problem, the depth of channels is generally increased to minimize the effect of surface tension. However, the deeper the channels are, the thicker the fuel flow board is; it is thus difficult to make the fuel cell skinny.

Therefore, an improved fuel flow board of a fuel cell is provided to overcome the aforesaid disadvantages.

### SUMMARY OF THE INVENTION

It is a primary object of the invention to provide a fuel flow board of a fuel cell, which has deeper channels regarding to the thickness of the fuel flow board.

It is another object of the invention to provide a fuel flow board of a fuel cell, which includes deeper channels and a particular cross-section of the channels to minimize the effect of surface tension.

It is yet another object of the invention to provide a fuel flow board of a fuel cell comprising a channel-separating structure, which is advantageous to the module and fabrication of a fuel flow board.

In accordance with the aforesaid objects of the invention, a fuel flow board of a fuel cell is provided. The fuel flow board is sandwiched between an upper fuel cell board and a lower fuel cell board, and each fuel cell board includes at least a membrane electrode assembly. The fuel flow board comprises a substrate having a first surface, a second surface and a fuel flowing channel. The fuel flowing channel is individually disposed on each surface in the form of a concave flow-guiding structure. The first surface and the second surface are contacted with the upper fuel cell board and the lower fuel cell board, respectively. The fuel flowing channel on each surface includes a plurality of trenches defined in parallel. The trenches are disposed corresponding to membrane electrode assemblies of the upper fuel cell board and the lower fuel cell board, and are spaced apart and interlaced on the first surface and the second surface.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is an elevation view of a fuel cell having a fuel flow board in accordance with the first embodiment of the invention;

FIG. 2 shows the cross-section view of FIG. 1;

FIG. 3 shows the plan view of the fuel flow board in FIG. 1).;

FIG. 4 shows the cross-section view of a fuel flow board for a fuel cell according to the second embodiment of the invention;

FIG. 5 shows the cross-section view of a fuel flow board for a fuel cell according to the third embodiment of the invention;

FIG. 6 shows the exploded cross-section view of a fuel flow board for a fuel cell according to the forth embodiment of the invention;

FIG. 7 shows the cross-section view of FIG. 6;

FIG. 8 shows the exploded cross-section view of a fuel flow board for a fuel cell according to the fifth embodiment of the invention; and

FIG. 9 shows the cross-section view of FIG. 8.

### DETAILED DESCRIPTION OF THE INVENTION

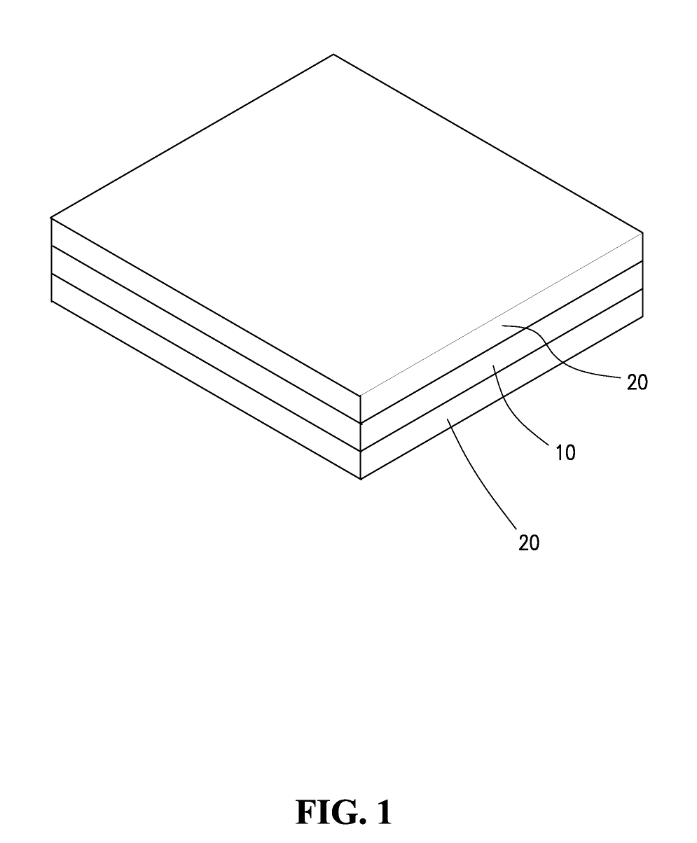

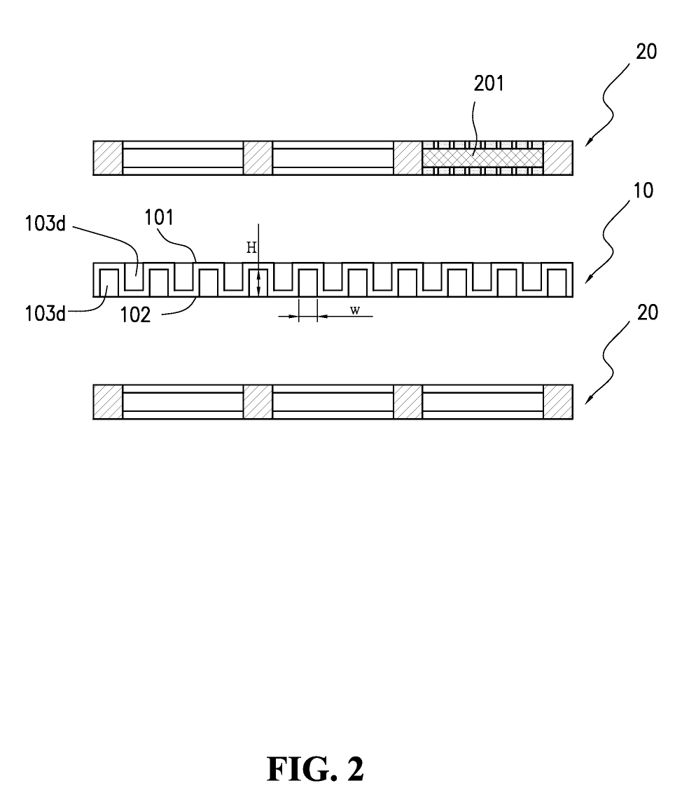

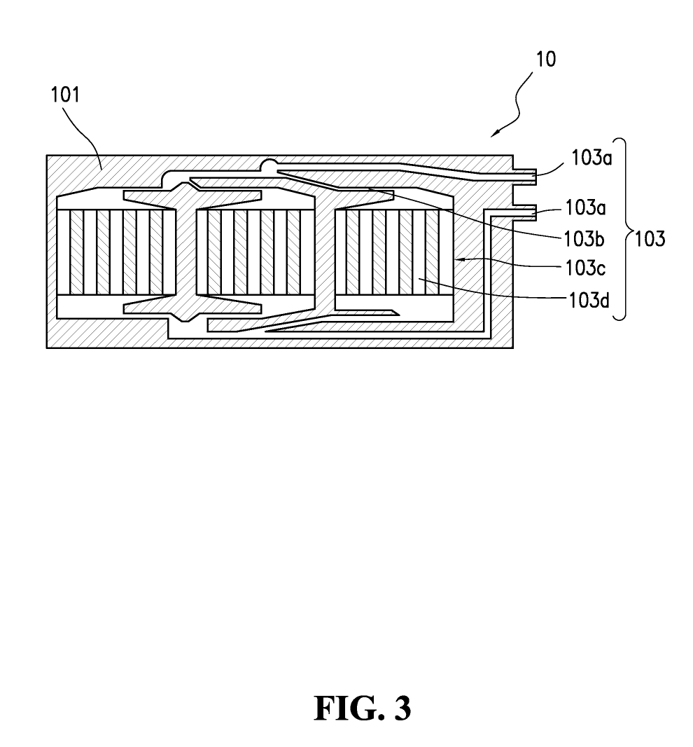

FIG. 1 is an elevation view of a fuel cell having a fuel flow board according to the first embodiment of the invention, FIG. 2 shows the cross-section view of FIG. 1, and FIG. 3 shows the plan view of the fuel flow board in FIG. 1. Referring to FIG. 1, FIG. 2 and FIG. 3, a fuel flow board 10 for a fuel cell includes a first surface 101 and a second surface 102 to be contacted with an upper fuel cell board 20 and a lower fuel cell board 20, respectively. The fuel cell board 20 may be a power generator made from the manufacture process of printed circuit boards (PCBs). For example, the fuel cell board 20 is a direct methanol fuel cell (DMFC), of which substrate may include multi-layers of FR4 substrates, FR5 substrates, epoxy resin substrates, glass fiber substrates, ceramic substrates, polymeric plastic substrates, or composite substrates. Pluralities of cores with MEAs 201 are sandwiched in the sandwiched layers of substrates, in which the MEAs 201 are provided to perform electrochemical reactions and output power. The substrate of the fuel flow board 10 may be composed of FR4 substrates, FR5 substrates, epoxy resin substrates, glass fiber substrates, ceramic substrates, polymeric plastic substrates, or composite substrates. The first surface 101 or the second surface 102 of the fuel flow board 10 individually includes fuel flowing channels 103. The channels 103 are embedded in the surfaces 101, 102 of the fuel flow board 10, so as to form a flow-guiding structure, and include a plurality of inlets 103a, a plurality of leading portions 103b and a plurality of contact portions 103c.

Each inlet 103a of the channel 103 penetrates through the side of the fuel flow board 10 to connect with an external fuel supplier (not shown). The leading portion 103b is a concave structure on the surface of the fuel flow board 10, and connects to the inlet 103a and a corresponding contact portion 103c. The contact portion 103c includes parallel trenches 103d that are rectangular concave structures on the surface of the fuel flow board 10. The trenches 103d on the first surface 101 of the fuel flow board 10 and the trenches 103d on the second surface 102 of the fuel flow board 10 are spaced apart and interlaced each other. The trench 103d has a width W and a depth H. The fuel flow board 10 can be designed to have a thickness approximate to the depth H such that the thickness of the fuel flow board 10 can be substantially minimized as the depth H of the trench 103d is maintained.

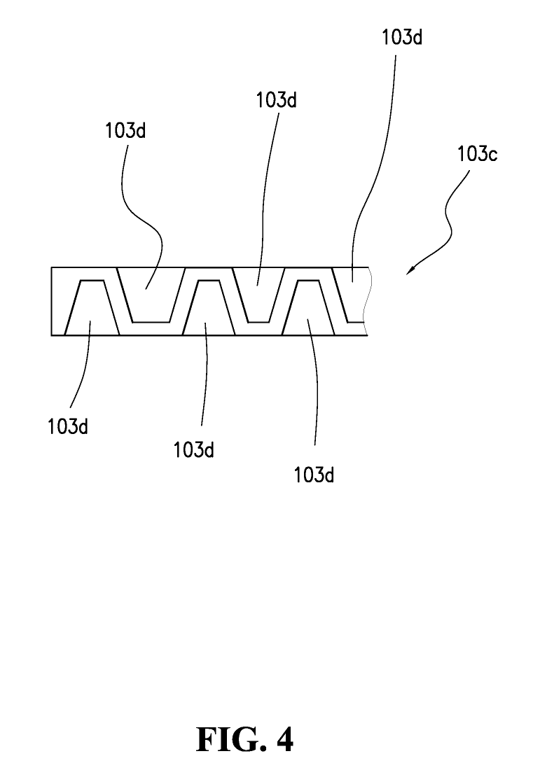

FIG. 4 shows the cross-section view of a fuel flow board for a fuel cell according to the second embodiment of the invention. Each contact portion 103c comprises a plurality of trenches 103d defined in parallel. The trenches 103d are trapezoid concave structures on the surface of the fuel flow board 10.

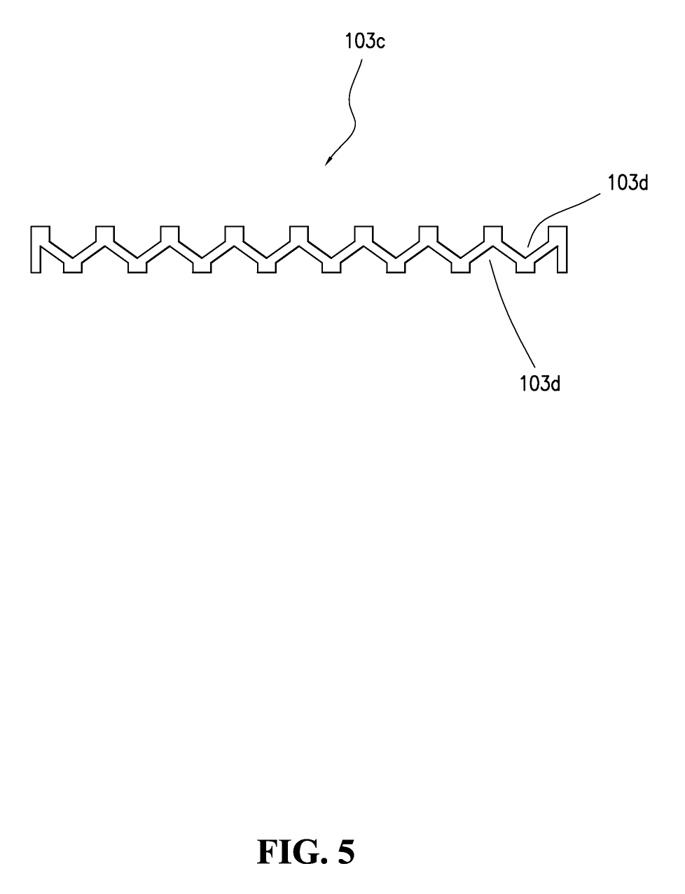

FIG. 5 shows the cross-section view of a fuel flow board for a fuel cell according to the third embodiment of the invention. Each contact portion 103c comprises a plurality of trenches 103d defined in parallel, and the trenches 103d are half-hexagonal concave structures on the surface of the fuel flow board 10.

Though several embodiments are described above, the invention is not limited to the geometry of the trench 103d as illustrated in FIG. 2, FIG. 4 and FIG. 5. Other structures or geometries are also claimed within the scope of the invention, as long as the trenches 103d on the first surface ).101 of the fuel flow board 10 and the trenches 103d on the second surface 102 of the fuel flow board 10 are spaced apart and interlaced each other, and the width W and depth H of the trenches 103d as well as the ratio of width W to depth H are designed to decrease their surface tension, preventing bubbles from accumulating and blocking channels. Moreover, the trenches 103d of the contact portion 103c are preferably deployed corresponding to the position of each MEA 201 in the fuel cell board 20.

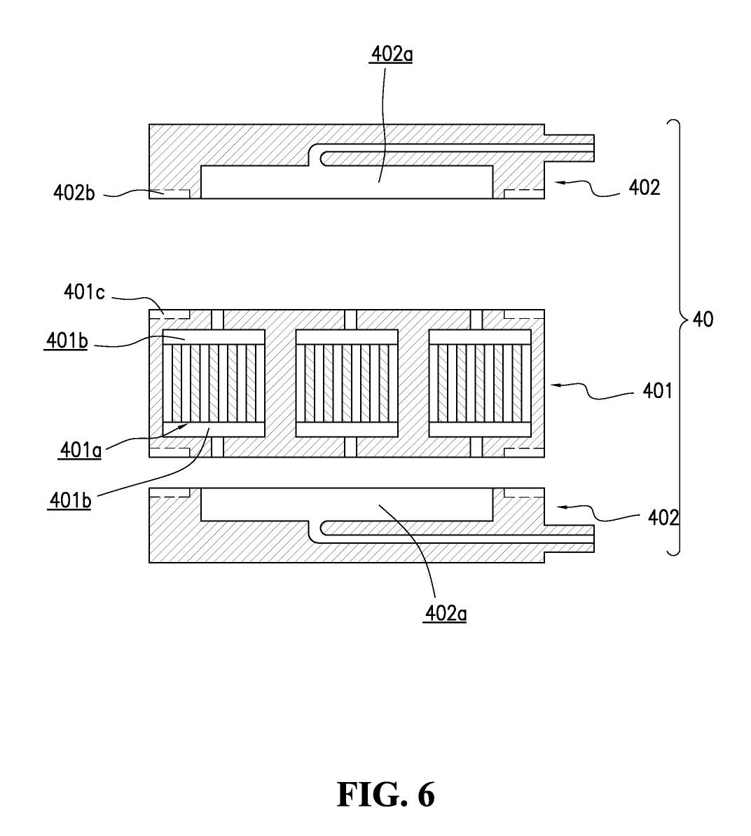

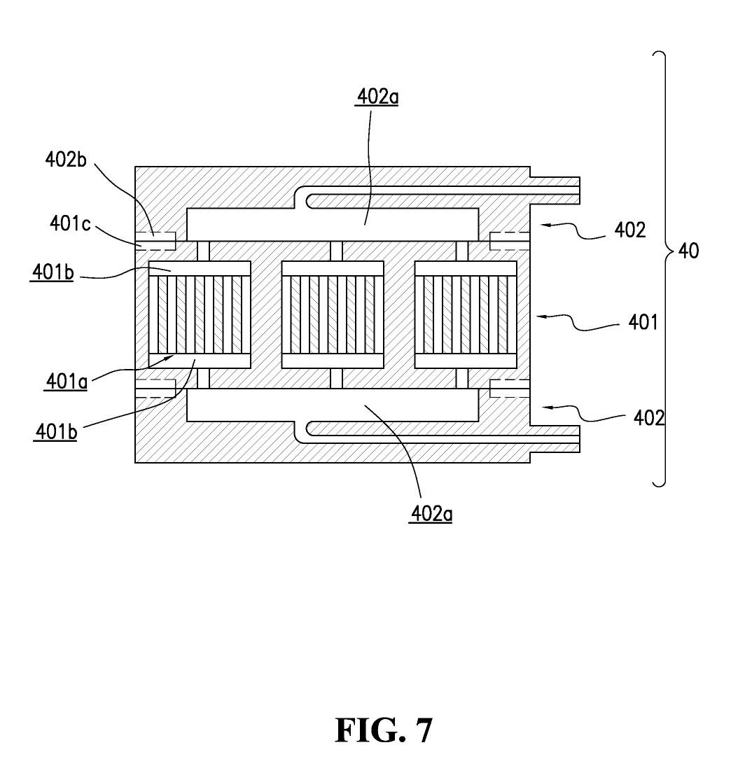

FIG. 6 shows the exploded cross-section view of a fuel flow board for a fuel cell according to the forth embodiment of the invention. FIG. 7 shows the cross-section view of FIG. 6. A fuel flow board 40 is in the form of a channel-separating structure, which is composed of a first substrate 401 and two second substrates 402, and two sides of the first substrate 401 are individually connected to second substrates 402. A contact portion 401a is formed on the surface of the first substrate 401, and a first leading portion 402a is formed on the surface of the second substrate 402. Second leading portions 401b corresponding to the first leading portion 402a are respectively formed on two sides of each contact portion 401a, so the contact portions 401a, the second leading portions 401b and the first leading portions 402a of the first substrate 401 and the second substrate 402 constitute a fuel flowing channel after being combined. The first substrate 401 and the second substrate 402 separately include a first combination 401c and a second combination 402b that are opposite to each other. The first combination 401c and the second combination 402b are provided to integrate the first substrate 401 and the second substrate 402. The first leading portion 402a is concave inwardly for directing flow. One end, thereof, laterally passes through the fuel flow board 40 to form an inlet in communication with an external fuel supplier (not shown), and the other end thereof corresponds to and connects with the second leading portion 401b of the contact portion 401a. Each contact portion 401a includes a plurality of parallel trenches 103d that are concave structures on the surface of the fuel flow board 40. The second leading portion 401b is concave inwardly for connecting the contact portion 401a with the first leading portion 402a to guild fluid thereby.

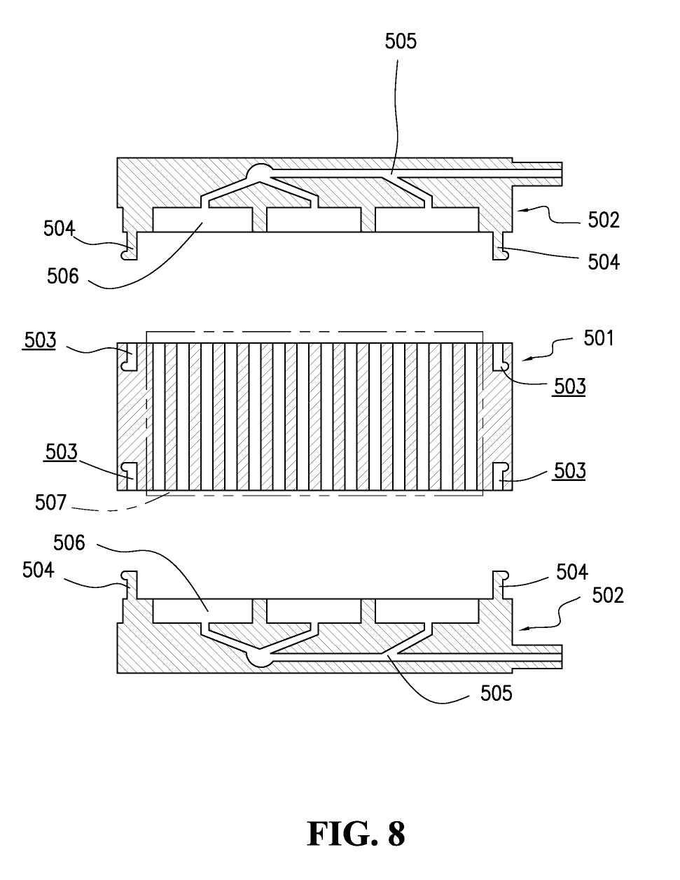

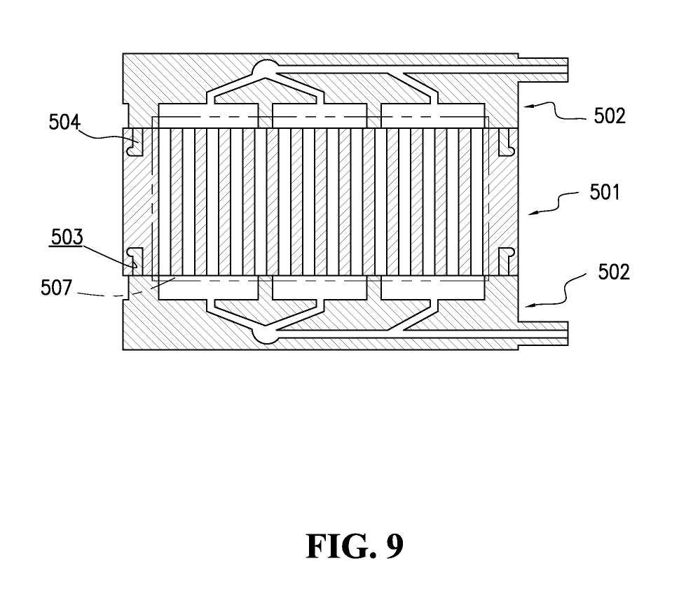

FIG. 8 shows the exploded cross-section view of a fuel flow board for a fuel cell according to the fifth embodiment of the invention. FIG. 9 shows the cross-section view of FIG. 8. A first substrate 501 and two second substrates 502 separately include first combinations 503 and second combinations 504. The first combinations 503 and the second combinations 504 constitute a coupling structure for combining the first substrate 501 and the second substrate 502. For example, the first combination 503 may be an inserting hole punching along the planar direction, and the second combination 504 may be a protruding bar extending in the planar direction. The inserting hole and the protruding bar form the coupling structure. After the protruding bar is inset into the inserting hole, the inserting hole and the protruding bar are fastened mutually, and hence the first substrate 501 and the second substrates 502 are integrated with each other.

Furthermore, the first leading portion 505 and the second leading portion 506 are formed on the surface of the second substrate 502, and the contact portion 507 is formed on the surface of the first substrate 501. The first leading portion 505 may shape a uniform diverged structure or a uniform converged structure by which the flow out of the first leading portion 505 is distributed to each second leading portion 506 averagely, or the flow from each second leading portion 506 is collected into the first leading portion 505 averagely.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel flow board for a fuel cell, the fuel flow board is sandwiched between an upper fuel cell board and a lower fuel cell board, each fuel cell board includes at least a membrane electrode assembly (MEA), the fuel flow board comprising:
a substrate having a first surface, a second surface and a fuel flowing channel, wherein the fuel flowing channel is individually disposed on each surface in the form of a concave flow-guiding structure,
wherein the first surface and the second surface are respectively contacted with the upper fuel cell board and the lower fuel cell board;
wherein the fuel flowing channel on each surface includes a plurality of trenches defined in parallel, the trenches are disposed corresponding to membrane electrode assemblies of the upper fuel cell board and the lower fuel cell board, the trenches are spaced apart and interlaced on the first surface and the second surface.

2. The fuel flow board of claim 1, wherein the fuel flow board is made from a material selected from a group consisting of a FR4 substrate, a FR5 substrate, an epoxy resin substrate, a glass fiber substrate, a ceramic substrate, a polymeric plastic substrate, and a composite substrate.

3. The fuel flow board of claim 1, wherein the fuel cell board is selected from a group consisting of a FR4 substrate, a FR5 substrate, an epoxy resin substrate, a glass fiber substrate, a ceramic substrate, a polymeric plastic substrate, and a composite substrate.

4. The fuel flow board of claim 1, wherein the trenches comprise a trapezoid concave structure, a rectangular concave structure, a half-hexagonal concave structure, or a composition thereof.

5. The fuel flow board of claim 1, wherein a width and a depth of the trenches and a ratio of the width to the depth are designed to decrease surface tension.

6. The fuel flow board of claim 1, wherein the substrate is a single piece substrate.

7. The fuel flow board of claim 1, wherein the substrate comprises a piece of a first substrate and two pieces of second substrates, and the trenches are disposed on the first substrate, wherein two sides of the first substrate are separately connected with the two second substrates, and a first combination of the first substrate corresponds to a second combination of the second substrate such that the first substrate and the second substrate are joined together.

8. The fuel flow board of claim 7, wherein the fuel flowing channel further comprises a first leading portion and a second leading portion, the first leading portion is in communication with the second leading portion, and the second leading portion is in communication with the trenches.

9. The fuel flow board of claim 8, wherein the first leading portion is formed on a surface of the second substrate.

10. The fuel flow board of claim 9, wherein the second leading portion is formed on a surface of the first substrate.

11. The fuel flow board of claim 9, wherein the second leading portion is formed on a surface of the second substrate.

12. The fuel flow board of claim 7, wherein the first combination is an inserting hole, and the second combination is a protruding bar for fastening the inserting hole.

13. The fuel flow board of claim 8, wherein the first leading portion shapes a uniform diverged structure, a uniform converged structure, or a composition thereof and thereby flow out of the first leading portion is distributed to each second leading portion averagely.

14. The fuel flow board of claim 8, wherein the second leading portion shapes a uniform diverged structure, a uniform converged structure, or a composition thereof and thereby flow from the second leading portion is distributed to the trenches averagely.
